(19) United States
(12) Patent Application Publication
(10) Pub. No.: US 2026/0288921 A1
(43) Pub. Date: Sep. 24, 2026

(54) HAND ID ON EXTENDED REALITY DEVICES

(71) Applicant: Snap Inc., Santa Monica, CA (US)

(72) Inventors: Kai Zhou, Wiener Neudorf (AT); Robert Fischer, Vienna (AT); Adrian Schoisengeier, Vienna (AT); Connor Cabrera, Weehawken, NJ (US)

(21) Appl. No.: 19/084,481

(22) Filed: Mar. 19, 2025

(51) Int. Cl. G06F 21/32; G06V 10/141; G06V 20/20; G06V 40/12; G06V 40/14

(52) U.S. Cl. CPC G06F 21/32; G06V 10/141; G06V 20/20; G06V 40/1365; G06V 40/14

(57) ABSTRACT

An eXtended Reality (XR) device is provided that uses images of a dorsal surface of a hand of a user to authenticate the user. The XR device captures, using a set of cameras, images of a hand of a user and processes these images to generate enhanced vein patterns. The XR device generates authentication features based on the enhanced vein patterns and performs classification using the authentication features. Based on the classification, the XR device controls access to specific content and applications. The XR device includes an infrared camera and emitter to optimize vein pattern visibility, processes images using computer vision algorithms, and performs lightweight classification on-device while maintaining user privacy.

### TECHNICAL FIELD

The present disclosure relates generally to user authentication and, more particularly, to user authentication for extended reality devices.

### BACKGROUND

A head-wearable apparatus can be implemented with a transparent or semi-transparent display through which a user of the head-wearable apparatus can view the surrounding environment. Such head-wearable apparatuses enable a user to see through the transparent or semi-transparent display to view the surrounding environment, and to also see objects (e.g., objects such as a rendering of a 2D or 3D graphic model, images, video, text, and so forth) that are generated for display to appear as a part of, and/or overlaid upon, the surrounding environment. This is typically referred to as “augmented reality” or “AR.” A head-wearable apparatus can additionally completely occlude a user's visual field and display a virtual environment through which a user can move or be moved. This is typically referred to as “virtual reality” or “VR.” In a hybrid form, a view of the surrounding environment is captured using cameras, and then that view is displayed along with augmentation to the user on displays the occlude the user's eyes. As used herein, the term eXtended Reality (XR) refers to augmented reality, virtual reality and any of hybrids of these technologies unless the context indicates otherwise.

A user of the head-wearable apparatus can access and use a computer software application to perform various tasks or engage in an activity. To use the computer software application, the user interacts with a user interface provided by the head-wearable apparatus.

### BRIEF DESCRIPTION OF THE SEVERAL VIEWS OF THE DRAWINGS

In the drawings, which are not necessarily drawn to scale, like numerals can describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A is a perspective view of a head-wearable apparatus, according to some examples.

FIG. 1B illustrates a further view of the head-wearable apparatus of FIG. 1A, according to some examples.

FIG. 2 illustrates a system in which the head-wearable apparatus is operably connected to a mobile device, according to some examples.

FIG. 3 is a diagrammatic representation of a machine in the form of a computer system, according to some examples.

FIG. 4A illustrates a collaboration diagram of components of an XR device, according to some examples.

FIG. 4B illustrates a hand ID method, according to some examples.

FIG. 4C illustrates a progression of image enhancement, according to some examples.

FIG. 5A illustrates a machine-learning pipeline, according to some examples.

FIG. 5B illustrates training and use of a machine-learning program, according to some examples.

FIG. 6 is a block diagram showing a software architecture, according to some examples.

### DETAILED DESCRIPTION

The widespread adoption of XR devices has created new challenges for user authentication and security. Traditional authentication methods such as fingerprint recognition and facial identification, while effective for mobile devices, are not optimized for the unique form factor and usage patterns of XR glasses. These conventional approaches often require specific hardware configurations or user interactions that are impractical for XR device implementations.

Authentication systems for XR devices face technical constraints related to on-device processing capabilities. While XR devices possess substantial computing power, they cannot support the resource-intensive authentication methods commonly deployed on other computing platforms. This limitation has led many existing solutions to rely on remote server processing, which introduces privacy concerns, particularly in jurisdictions with strict data protection regulations. The transmission of biometric authentication data to remote servers, potentially located in different countries, presents both legal and security challenges.

Current XR authentication systems also struggle with environmental variability. The effectiveness of these systems can be significantly impacted by different lighting conditions, varying user characteristics such as age and skin tone, and the practical limitations of capturing biometric data while the device is being worn. Additionally, the unique optical and sensor configurations of XR devices create specific technical challenges related to providing effective user feedback during the authentication process, as the camera field of view often differs from the display field of view.

Furthermore, existing biometric authentication approaches for XR devices have not adequately addressed the need for consistent performance across different usage scenarios. Voice authentication, fingerprint recognition, and palm-based systems each present their own limitations when applied to XR devices, particularly in maintaining reliable authentication while preserving user privacy and operating within device resource constraints. These challenges have created a clear need for an authentication solution specifically designed for XR device architectures that can provide robust security while respecting user privacy and device limitations.

The methodologies described in this disclosure provide an on-device authentication system for an XR device that uses dorsal hand vein patterns as a unique physiological identifier. The methodologies employ a two-stage architecture combining computer vision with neural network-based feature extraction to process near-infrared images of hand veins. This architecture enables efficient on-device processing while maintaining high accuracy, eliminating the need for remote server communication. The methodologies enhance authentication reliability by incorporating multiple physiological features, including hand shape and finger proportions, while automatically adjusting IR camera parameters to optimize vein visibility across different environmental conditions.

In some examples, near-infrared imaging is used to capture unique dorsal hand vein patterns of a hand of a user.

In some examples, a resource-efficient two-stage processing architecture enables on-device authentication without using an external server.

In some examples, a multi-modal biometric analysis incorporates hand shape and proportions with the dorsal hand vein patterns.

In some examples, automatic adjustment of imaging parameters ensure consistent performance of a system using dorsal hand vein patterns for user identification.

Other technical features can be readily apparent to one skilled in the art from the following figures, descriptions, and claims.

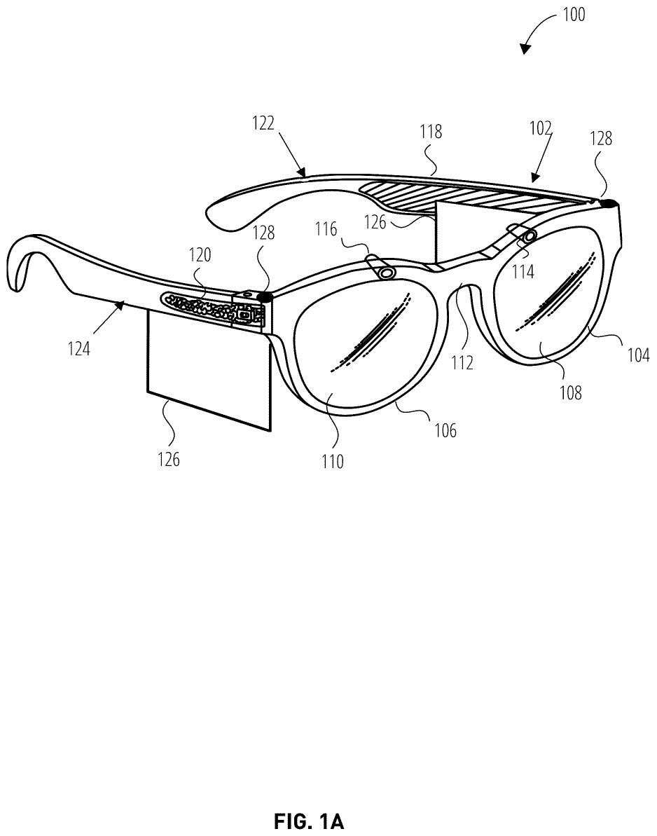

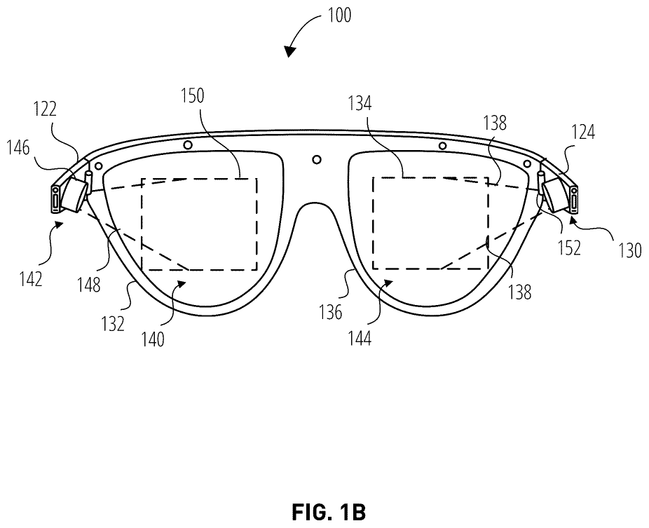

FIG. 1A is a perspective view of an XR device configured as a head-wearable apparatus 100 according to some examples. The head-wearable apparatus 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the head-wearable apparatus 100.

The frame 102 additionally includes a left arm or left temple piece 122 and a right arm or right temple piece 124. In some examples, the frame 102 can be formed from a single piece of material so as to have a unitary or integral construction.

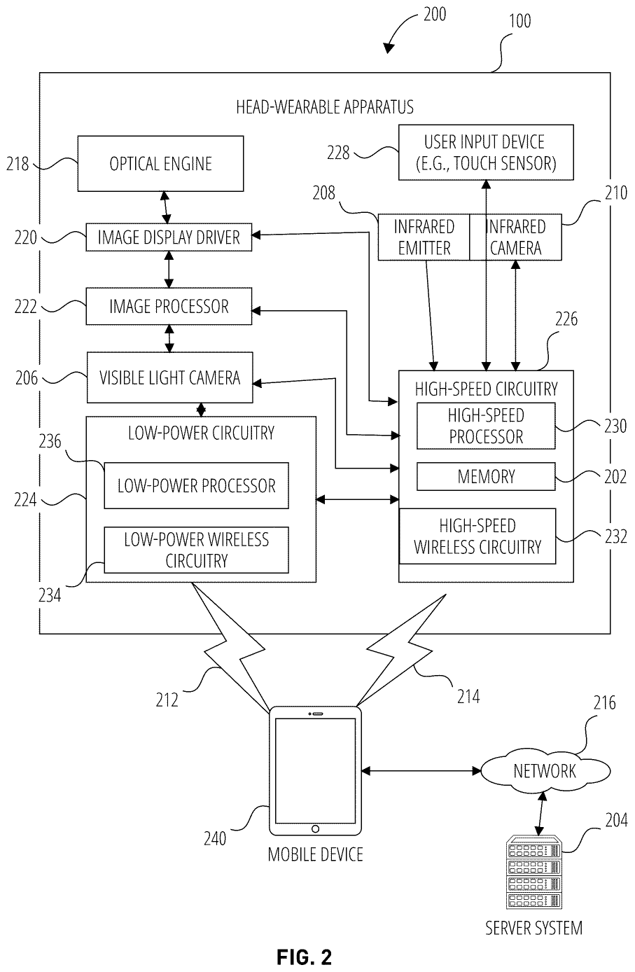

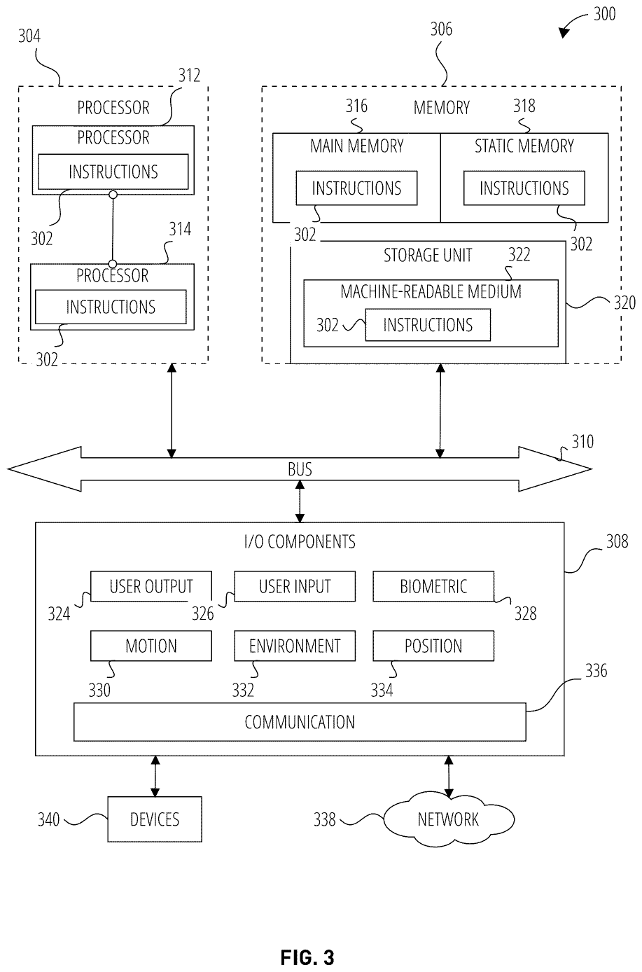

The head-wearable apparatus 100 can include a machine (e.g., machine 300 of FIG. 3) capable of computation, such as computer 120 or the like, which can be of any suitable type so as to be carried by the frame 102 and, in one or more examples, of a suitable size and shape, so as to be partially disposed in one of the left temple piece 122 or the right temple piece 124. The computer 120 can include one or more processors with memory, wireless communication circuitry, and a power source. As discussed below in reference to FIG. 2, the computer 120 comprises low-power circuitry 224, high-speed circuitry 226, and a display processor. Various other examples can include these elements in different configurations or integrated together in different ways. Additional details of aspects of the computer 120 can be implemented as illustrated by the machine 300 discussed herein.

The computer 120 additionally includes a battery 118 or other suitable portable power supply. In some examples, the battery 118 is disposed in left temple piece 122 and is electrically coupled to the computer 120 disposed in the right temple piece 124. The head-wearable apparatus 100 can include a connector or port (not shown) suitable for charging the battery 118, a wireless receiver, transmitter or transceiver (not shown), or a combination of such devices.

The head-wearable apparatus 100 includes a first or left camera 114 and a second or right camera 116. Although two cameras are depicted, other examples contemplate the use of a single or additional cameras (e.g., two or more cameras).

In some examples, the head-wearable apparatus 100 includes any number of input sensors or other input/output devices in addition to the left camera 114 and the right camera 116. Such sensors or input/output devices can additionally include biometric sensors, location sensors, motion sensors, and so forth.

In some examples, the left camera 114 and the right camera 116 provide tracking image data for use by the head-wearable apparatus 100 to extract 3D information from a real-world scene.

The head-wearable apparatus 100 can also include a touchpad 126 mounted to or integrated with one or both of the left temple piece 122 and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input can be provided by one or more buttons 128, which in the illustrated examples are provided on the outer upper edges of the left optical element holder 104 and right optical element holder 106. The one or more touchpads 126 and buttons 128 provide a means whereby the head-wearable apparatus 100 can receive input from a user of the head-wearable apparatus 100.

FIG. 1B illustrates the head-wearable apparatus 100 from the perspective of a user while wearing the head-wearable apparatus 100. For clarity, a number of the elements shown in FIG. 1A have been omitted. As described in FIG. 1A, the head-wearable apparatus 100 shown in FIG. 1B includes left optical element 140 and right optical element 144 secured within the left optical element holder 132 and the right optical element holder 136 respectively.

The head-wearable apparatus 100 includes right forward optical assembly 130 comprising a left near eye display 150, a right near eye display 134, and a left forward optical assembly 142 including a left projector 146 and a right projector 152.

In some examples, the near eye displays are waveguides. The waveguides include reflective or diffractive structures (e.g., gratings and/or optical elements such as mirrors, lenses, or prisms). Light 138 emitted by the right projector 152 encounters the diffractive structures of the waveguide of the right near eye display 134, which directs the light towards the right eye of a user to provide an image on or in the right optical element 144 that overlays the view of the real-world scene seen by the user. Similarly, light 148 emitted by the left projector 146 encounters the diffractive structures of the waveguide of the left near eye display 150, which directs the light towards the left eye of a user to provide an image on or in the left optical element 140 that overlays the view of the real-world scene seen by the user. The combination of a Graphical Processing Unit, an image display driver, the right forward optical assembly 130, the left forward optical assembly 142, left optical element 140, and the right optical element 144 provide an optical engine of the head-wearable apparatus 100. The head-wearable apparatus 100 uses the optical engine to generate an overlay of the real-world scene view of the user including display of a user interface to the user of the head-wearable apparatus 100.

It will be appreciated however that other display technologies or configurations can be utilized within an optical engine to display an image to a user in the user's field of view. For example, instead of a projector and a waveguide, an LCD, LED or other display panel or surface can be provided.

In use, a user of the head-wearable apparatus 100 will be presented with information, content and various user interfaces on the near eye displays. As described in more detail herein, the user can then interact with the head-wearable apparatus 100 using a touchpad 126 and/or the button 128, voice inputs or touch inputs on an associated device (e.g. mobile device 240 illustrated in FIG. 2), and/or hand movements, locations, and positions recognized by the head-wearable apparatus 100.

In some examples, an optical engine of an XR device is incorporated into a lens that is in contact with a user's eye, such as a contact lens or the like. The XR device generates images of an XR experience using the contact lens.

In some examples, the head-wearable apparatus 100 comprises an XR device. In some examples, the head-wearable apparatus 100 is a component of an XR device including additional computational components. In some examples, the head-wearable apparatus 100 is a component in an XR device comprising additional user input systems or devices.

FIG. 2 illustrates a system 200 including a head-wearable apparatus 100, according to some examples. FIG. 2 is a high-level functional block diagram of an example head-wearable apparatus 100 communicatively coupled to a mobile device 240 and various server systems 204 via various communication protocols.

The head-wearable apparatus 100 includes set of cameras, each of which can be, for example, a visible light camera 206, an infrared camera 210, and the like. The head-wearable apparatus 100 can also include an infrared emitter 208 useful to illuminate a field of view of an infrared camera 210.

The mobile device 240 connects with head-wearable apparatus 100 using both a low-power wireless connection 212 and a high-speed wireless connection 214. The mobile device 240 is also connected to the server system 204 and the networks 216.

The head-wearable apparatus 100 further includes one or more image displays of the optical engine 218. The optical engines 218 include one associated with the left lateral side and one associated with the right lateral side of the head-wearable apparatus 100. The head-wearable apparatus 100 also includes an image display driver 220, an image processor 222, low-power circuitry 224, and high-speed circuitry 226. The optical engine 218 is for presenting images and videos, including an image that can include a graphical user interface to a user of the head-wearable apparatus 100.

The image display driver 220 commands and controls the optical engine 218. The image display driver 220 can deliver image data directly to the optical engine 218 for presentation or can convert the image data into a signal or data format suitable for delivery to the image display device. For example, the image data can be video data formatted according to compression formats, such as H.264 (MPEG-4 Part 10), HEVC, Theora, Dirac, RealVideo RV40, VP8, VP9, or the like, and still image data can be formatted according to compression formats such as Portable Network Group (PNG), Joint Photographic Experts Group (JPEG), Tagged Image File Format (TIFF) or exchangeable image file format (EXIF) or the like.

The head-wearable apparatus 100 includes a frame and stems (or temples) extending from a lateral side of the frame. The head-wearable apparatus 100 further includes a user input device 228 (e.g., touch sensor or push button), including an input surface on the head-wearable apparatus 100. The user input device 228 (e.g., touch sensor or push button) is to receive from the user an input selection to manipulate the graphical user interface of the presented image.

The components shown in FIG. 2 for the head-wearable apparatus 100 are located on one or more circuit boards, for example a PCB or flexible PCB, in the rims or temples. Alternatively, or additionally, the depicted components can be located in the chunks, frames, hinges, or bridge of the head-wearable apparatus 100. Left and right visible light cameras 206 can include digital camera elements such as a complementary metal oxide-semiconductor (CMOS) image sensor, charge-coupled device, camera lenses, or any other respective visible or light-capturing elements that can be used to capture data, including images of scenes with unknown objects.

The head-wearable apparatus 100 includes a memory 202, which stores instructions to perform a subset, or all the functions described herein. The memory 202 can also include storage device.

As shown in FIG. 2, the high-speed circuitry 226 includes a high-speed processor 230, a memory 202, and high-speed wireless circuitry 232. In some examples, the image display driver 220 is coupled to the high-speed circuitry 226 and operated by the high-speed processor 230 to drive the left and right image displays of the optical engine 218. The high-speed processor 230 can be any processor capable of managing high-speed communications and operation of any general computing system needed for the head-wearable apparatus 100. The high-speed processor 230 includes processing resources needed for managing high-speed data transfers on a high-speed wireless connection 214 to a wireless local area network (WLAN) using the high-speed wireless circuitry 232. In certain examples, the high-speed processor 230 executes an operating system such as a LINUX operating system or other such operating system of the head-wearable apparatus 100, and the operating system is stored in the memory 202 for execution. In addition to any other responsibilities, the high-speed processor 230 executing a software architecture for the head-wearable apparatus 100 is used to manage data transfers with high-speed wireless circuitry 232. In certain examples, the high-speed wireless circuitry 232 is configured to implement Institute of Electrical and Electronic Engineers (IEEE) 802.11 communication standards, also referred to herein as WI-FI®. In some examples, other high-speed communications standards can be implemented by the high-speed wireless circuitry 232.

The low-power wireless circuitry 234 and the high-speed wireless circuitry 232 of the head-wearable apparatus 100 can include short-range transceivers (e.g., Bluetooth™, Bluetooth LE, Zigbee, ANT+) and wireless wide, local, or wide area Network transceivers (e.g., cellular or WI-FI®). Mobile device 240, including the transceivers communicating via the low-power wireless connection 212 and the high-speed wireless connection 214, can be implemented using details of the architecture of the head-wearable apparatus 100, as can other elements of the network 216.

The memory 202 includes any storage device capable of storing various data and applications, including, among other things, camera data generated by the left and right visible light cameras 206, the infrared camera 210, and the image processor 222, as well as images generated for display by the image display driver 220 on the image displays of the optical engine 218. While the memory 202 is shown as integrated with high-speed circuitry 226, in some examples, the memory 202 can be an independent standalone element of the head-wearable apparatus 100. In certain such examples, electrical routing lines can provide a connection through a chip that includes the high-speed processor 230 from the image processor 222 or the low-power processor 236 to the memory 202. In some examples, the high-speed processor 230 can manage addressing of the memory 202 such that the low-power processor 236 will boot the high-speed processor 230 any time that a read or write operation involving memory 202 is needed.

As shown in FIG. 2, the low-power processor 236 or high-speed processor 230 of the head-wearable apparatus 100 can be coupled to the camera (visible light camera 206, infrared emitter 208, or infrared camera 210), the image display driver 220, the user input device 228 (e.g., touch sensor or push button), and the memory 202.

The head-wearable apparatus 100 is connected to a host computer. For example, the head-wearable apparatus 100 is paired with the mobile device 240 via the high-speed wireless connection 214 or connected to the server system 204 via the network 216. The server system 204 can be one or more computing devices as part of a service or network computing system, for example, that includes a processor, a memory, and network communication interface to communicate over the network 216 with the mobile device 240 and the head-wearable apparatus 100.

The mobile device 240 includes a processor and a Network communication interface coupled to the processor. The Network communication interface allows for communication over the network 216, low-power wireless connection 212, or high-speed wireless connection 214. The mobile device 240 can further store at least portions of the instructions in the memory of the mobile device 240 memory to implement the functionality described herein.

Output components of the mobile device 240 include visual components, such as a display such as a liquid crystal display (LCD), a plasma display panel (PDP), a light-emitting diode (LED) display, a projector, or a waveguide. The image displays of the optical assembly are driven by the image display driver 220. The output components of the mobile device 240 further include acoustic components (e.g., speakers), haptic components (e.g., a vibratory motor), other signal generators, and so forth. The input components of the mobile device 240, the mobile device 240, and server system 204, such as the user input device 228, can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 100 can also include additional peripheral device elements. Such peripheral device elements can include sensors and display elements integrated with the head-wearable apparatus 100. For example, peripheral device elements can include any I/O components including output components, motion components, position components, or any other such elements described herein.

In some examples, the head-wearable apparatus 100 can include biometric components or sensors to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, electroencephalogram-based identification, hand-based identification), and the like. Any biometric data collected by the biometric components or sensors is captured and stored with only user approval and deleted on user request, and in accordance with applicable laws. Further, such biometric data is used for very limited purposes, such as identification verification. To ensure limited and authorized use of biometric information and other Personally Identifiable Information (PII), access to this data is restricted to authorized personnel only, if at all. Any use of biometric data can strictly be limited to identification verification purposes, and the biometric data is not shared or sold to any third party without the explicit consent of the user. In addition, appropriate technical and organizational measures are implemented to ensure the security and confidentiality of this sensitive information. All biometric data is permanently destroyed when the initial purpose for collecting or obtaining such data has been satisfied.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude can be derived), orientation sensor components (e.g., magnetometers), and the like. Such positioning system coordinates can also be received over low-power wireless connections 212 and high-speed wireless connection 214 from the mobile device 240 via the low-power wireless circuitry 234 or high-speed wireless circuitry 232.

FIG. 3 is a diagrammatic representation of the machine 300 within which instructions 302 (e.g., software, a program, an application, an applet, an app, or other executable code) for causing the machine 300 to perform any one or more machine-implemented methodologies discussed herein can be executed. For example, the instructions 302 can cause the machine 300 to execute any one or more of the methods described herein. The instructions 302 transform the general, non-programmed machine 300 into a particular machine 300 programmed to carry out the described and illustrated functions in the manner described. The machine 300 can operate as a standalone device or can be coupled (e.g., networked) to other machines. In a networked deployment, the machine 300 can operate in the capacity of a server machine or a client machine in a server-client network environment, or as a peer machine in a peer-to-peer (or distributed) network environment. The machine 300 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 302, sequentially or otherwise, that specify actions to be taken by the machine 300. Further, while a single machine 300 is illustrated, the term “machine” shall also be taken to include a collection of machines that individually or jointly execute the instructions 302 to perform any one or more of the methodologies discussed herein. The machine 300, for example, can comprise a user system or any one of multiple server devices forming part of a server system. In some examples, the machine 300 can also comprise both client and server systems, with certain operations of a particular method or algorithm being performed on the server-side and with certain operations of the method or algorithm being performed on the client-side.

The machine 300 can include one or more hardware processors 304, memory 306, and input/output I/O components 308, which can be configured to communicate with each other via a bus 310.

The processor 304 can comprise one or more processors such as, but not limited to, processor 312 and processor 314. The one or more processors can comprise one or more types of processing systems such as, but not limited to, Central Processing Units (CPUs), Graphics Processing Units (GPUs), Digital Signal Processors (DSPs), Neural Processing Units (NPUs) or AI Accelerators, Physics Processing Units (PPUs), Field-Programmable Gate Arrays (FPGAs), Multi-core Processors, Symmetric Multiprocessing (SMP) Systems, and the like.

The memory 306 includes a main memory 316, a static memory 318, and a storage unit 320, both accessible to the processor 304 via the bus 310. The main memory 306, the static memory 318, and storage unit 320 store the instructions 302 embodying any one or more of the methodologies or functions described herein. The instructions 302 can also reside, completely or partially, within the main memory 316, within the static memory 318, within machine-readable medium 322 within the storage unit 320, within at least one of the processor 304 (e.g., within the processor's cache memory), or any suitable combination thereof, during execution thereof by the machine 300.

The I/O components 308 can include a wide variety of components to receive input, provide output, produce output, transmit information, exchange information, capture measurements, and so on. The specific I/O components 308 that are included in a particular machine will depend on the type of machine. For example, portable machines such as mobile phones can include a touch input device or other such input mechanisms, while a headless server machine will likely not include such a touch input device. It will be appreciated that the I/O components 308 can include many other components that are not shown in FIG. 3. In various examples, the I/O components 308 can include user output components 324 and user input components 326. The user output components 324 can include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 326 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 308 can include biometric components 328, motion components 330, environmental components 332, or position components 334, among a wide array of other components. For example, the biometric components 328 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Example types of BMI technologies, include:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

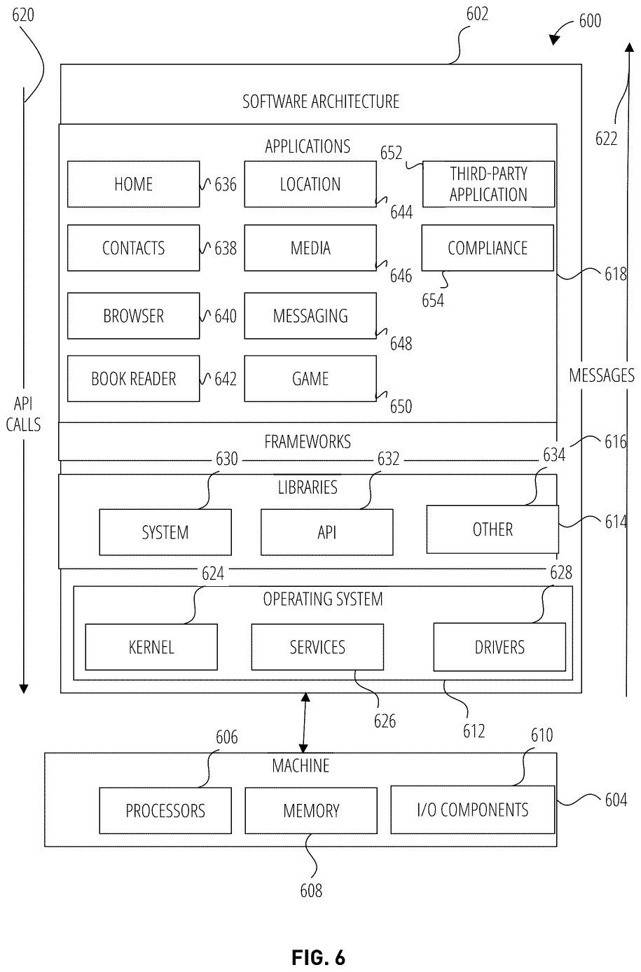

Any biometric data collected by the biometric components is captured and stored only with user approval and deleted on user request, and in accordance with applicable laws. Further, such biometric data can be used for very limited purposes, such as identification verification. To ensure limited and authorized use of biometric information and other Personally Identifiable Information (PII), access to this data is restricted to authorized personnel only, if at all. Any use of biometric data can strictly be limited to identification verification purposes, and the data is not shared or sold to any third party without the explicit consent of the user. Any biometric data is permanently deleted or otherwise destroyed when the initial purpose for collecting or obtaining the biometric data has been satisfied In addition, appropriate technical and organizational measures are implemented to ensure the security and confidentiality of this sensitive information as more fully described in reference to FIG. 6.

The motion components 330 include acceleration sensor components (e.g., accelerometer), gravitation sensor components, rotation sensor components (e.g., gyroscope).

The environmental components 332 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that can provide indications, measurements, or signals corresponding to a surrounding physical environment.

Communication can be implemented using a wide variety of technologies. The I/O components 308 further include communication components 336 operable to couple the machine 300 to a network 338 or devices 340 via respective coupling or connections. For example, the communication components 336 can include a network interface component or another suitable device to interface with the network 338. In further examples, the communication components 336 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 340 can be another machine or any of a wide variety of peripheral devices (e.g., a peripheral device coupled via a USB).

Moreover, the communication components 336 can detect identifiers or include components operable to detect identifiers. For example, the communication components 336 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information can be derived via the communication components 336, such as location via Internet Protocol (IP) geolocation, location via Wi-Fi® signal triangulation, location via detecting an NFC beacon signal that can indicate a particular location, and so forth.

The various memories (e.g., main memory 316, static memory 318, and memory of the processor 304) and storage unit 320 can store one or more sets of instructions and data structures (e.g., software) embodying or used by any one or more of the methodologies or functions described herein. These instructions (e.g., the instructions 302), when executed by processor 304, cause various operations to implement the disclosed examples.

The instructions 302 can be transmitted or received over the network 338, using a transmission medium, via a network interface device (e.g., a network interface component included in the communication components 336) and using any one of several well-known transfer protocols (e.g., hypertext transfer protocol (HTTP)). Similarly, the instructions 302 can be transmitted or received using a transmission medium via a coupling (e.g., a peer-to-peer coupling) to the devices 340.

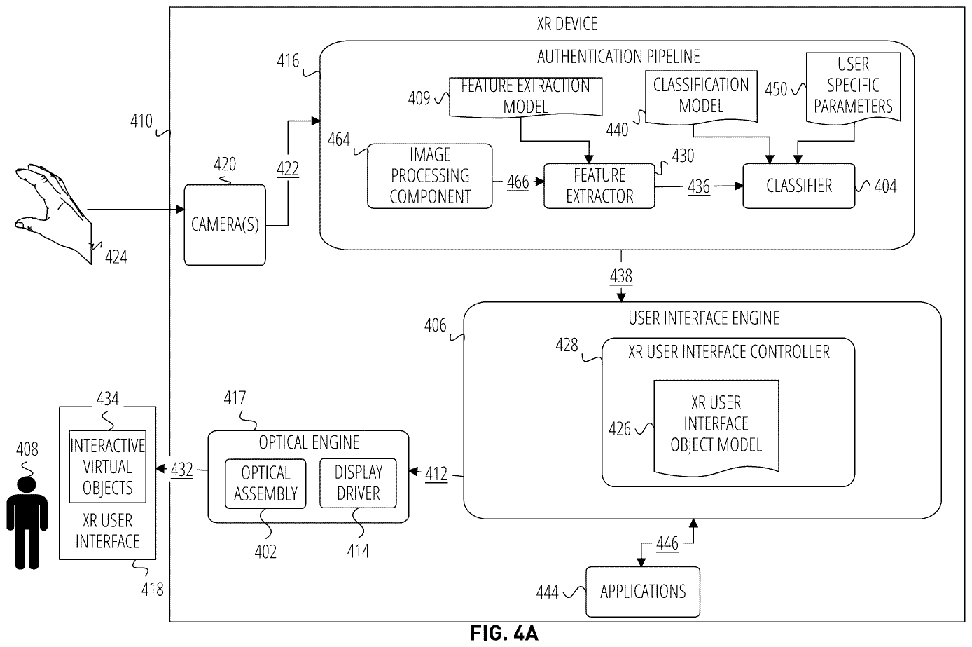

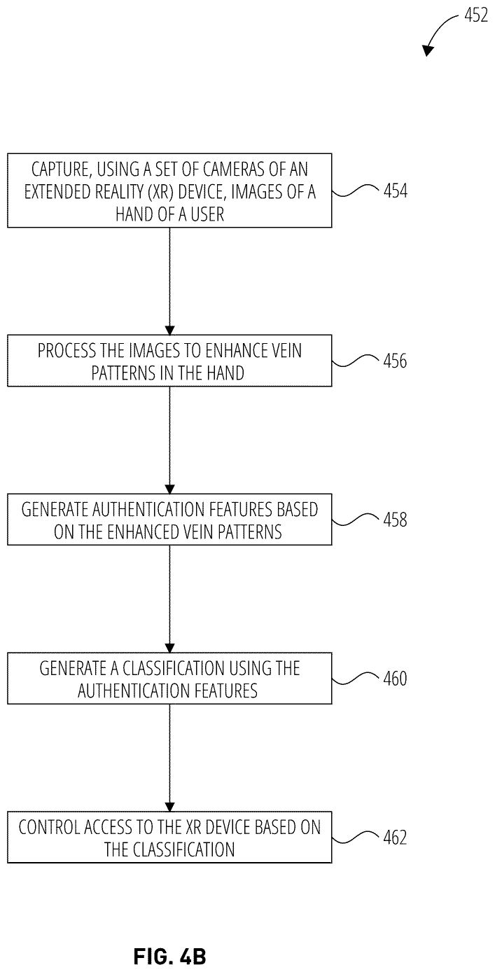

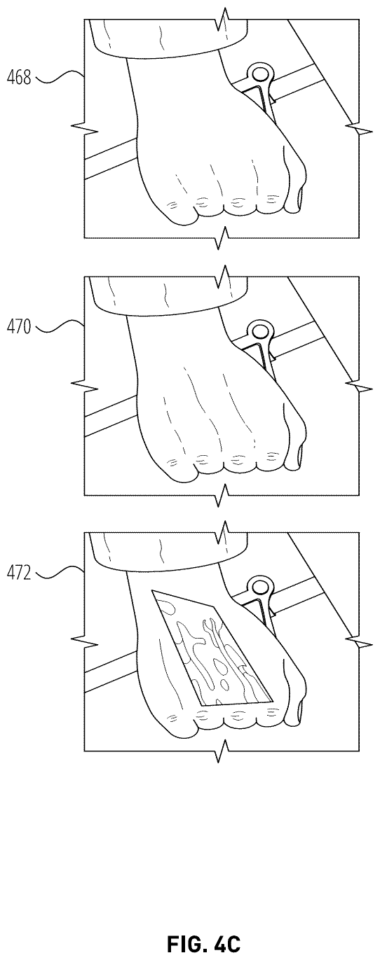

FIG. 4A illustrates a collaboration diagram of components of an XR device 410, such as head-wearable apparatus 100 of FIG. 1A, using hand-tracking for user input, FIG. 4B illustrates an example hand ID method 452 used by the XR device 410, and FIG. 4C illustrates a progression of image enhancement, according to some examples.

The XR device 410 provides an XR user interface 418 to a user 408 of the XR device 410 where the user 408 interacts with a set of interactive virtual objects 434 using hand-tracking input modalities. Using the hand-tracking input modalities, the XR device 410 generates user interface input/output (UI I/O) data 446 that are used by one or more applications 444 to generate one or more of the set of interactive virtual objects 434 as part of the one or more XR user interfaces 418. The applications 444 are executed by the XR device 410 and generate application user interfaces that provide features such as, but not limited to, maintenance guides, interactive maps, interactive tour guides, tutorials, and the like. The applications 444 can also be entertainment applications such as, but not limited to, video games, interactive videos, and the like.

The XR device 410 generates the XR user interface 418 provided to the user 408 within an XR environment. The XR user interface 418 include interactive virtual objects 434 that the user 408 can interact with. For example, a user interface engine 406 of FIG. 4A includes XR user interface controller 428 comprising a dialog script or the like that specifies a user interface dialog implemented by the XR user interface 418. The XR user interface controller 428 also comprises one or more actions that are to be taken by the XR device 410 based on detecting various dialog events such as user inputs input by the user 408 using the XR user interface 418 and by making hand gestures. The user interface engine 406 further includes an XR user interface object model 426. The XR user interface object model 426 includes 3D coordinate data of the interactive virtual objects 434. The XR user interface object model 426 also includes 3D graphics data of the interactive virtual objects 434. The 3D graphics data is used by an optical engine 417 to generate the XR user interface 418 for display to the user 408.

The user interface engine 406 generates XR user interface data 412 using the XR user interface object model 426. The XR user interface data 412 includes image data of the interactive virtual objects 434 of the XR user interface 418. The user interface engine 406 communicates the XR user interface data 412 to a display driver 414 of an optical engine 417 of the XR device 410. The display driver 414 receives the XR user interface data 412 and generates display control signals using the XR user interface data 412. The display driver 414 uses the display control signals to control the operations of one or more optical assemblies 402 of the optical engine 417. In response to the display control signals, the one or more optical assemblies 402 generate an XR user interface graphics display 432 of the XR user interface 418 that are provided to the user 408.

While in use, the XR device 410 uses a set of cameras 420 to detect and record a position, orientation, and gestures of the hands of the user 408. This can involve capturing the speed and trajectory of hand movements, recognizing specific hand poses, and determining the relative positioning of the hands in the three-dimensional space of an XR environment.

In some examples, the XR device 410 estimates hand landmarks including knuckle, wrist, and finger positions as part of generating authentication features. The XR device 410 analyzes these anatomical landmarks to create additional biometric identifiers that complement the vein pattern analysis.

In some examples, the XR device 410 implements a hand analysis system that precisely locates and tracks key anatomical landmarks on the hand 424. The feature extractor 430 identifies the positions of knuckles, wrist joints, and fingertips to establish a structural map of the hand. These landmarks provide important reference points for analyzing hand proportions and creating a more robust authentication profile.

In additional examples, the XR device 410 employs a landmark detection system that works in conjunction with vein pattern analysis. The XR device 410 can combine multiple physiological features including hand shape, finger proportions, and the like with dorsal vein patterns to enhance authentication accuracy. The precise detection of knuckle, wrist, and finger positions enables the XR device 410 to analyze the unique geometric relationships between these landmarks, which vary from person to person and provide additional discriminative features for authentication while maintaining efficient on-device processing.

In some examples, the set of cameras 420 comprise an array of optical sensors capable of capturing a wide range of hand movements and gestures in real-time as images. These sensors can include Red Green and Blue (RGB) cameras that capture images of the hands 424 of the user 408 using light having a broad wavelength spectrum, such as natural light provided by the real-world environment or artificial illumination created by one or more incandescent lamps, LED lamps, or the like provided by the XR device 410.

In some examples, the camera 420 can include infrared cameras that capture images of the hands 424 of the user 408 using energy in the infrared radiation (IR) spectrum. The IR energy can be supplied by one or more IR emitters of the XR device 410. In some examples, energy in the near-infrared spectrum is used. For example, the XR device 410 utilizes near-infrared light because it is absorbed by the hemoglobin in blood, making veins stand out from surrounding tissue. This physical property enables the XR device 410 to clearly visualize the dorsal hand vein patterns that serve as unique physiological identifiers. In additional examples, the XR device 410 implements an imaging system that optimizes the use of near-infrared energy for vein detection. The system can adjust the IR emitter intensity, exposure time, and gain to enhance vein visibility under different environmental conditions.

In some examples, the XR device 410 includes a set of pose sensors (not shown) such as an Inertial Measurement Unit (IMU) and the like, that track the orientation and movements of the XR device of the user 408. The pose sensors are used to determine Six Degrees of Freedom (6DoF) data of movement of the XR device 410 in three-dimensional space. Specifically, the 6DoF data encompasses three translational movements along the x, y, and z axes (forward/back, up/down, left/right) and three rotational movements (pitch, yaw, roll) included in pose data. In the context of XR, 6DoF data is allows for the tracking of both position and orientation of an object or user in 3D space.

In some examples, the pose sensors include a set of cameras that capture images of the real-world environment. The XR device 410 uses the images and photogrammetric methodologies to determine 6DoF data of the XR device 410.

In some examples, the XR device 410 uses a combination of an IMU and set of cameras to determine 6DoF for the XR device 410.

The XR device 410 uses an authentication pipeline 416 including a feature extractor 430 and a classifier 404 to generate classification data 438 using the image data 422 as more fully described in reference to FIG. 4B. The classification data 438 is used by the XR device 410 to authenticate the user 408 and control access to one or more of the

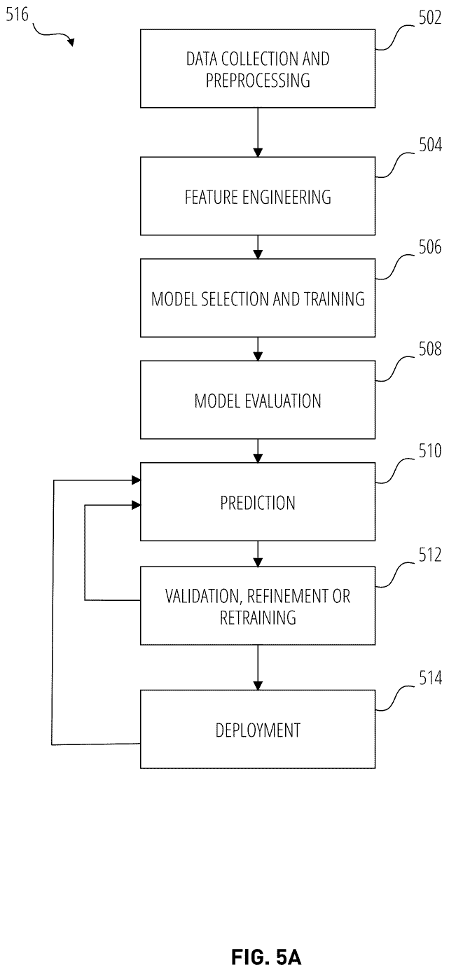

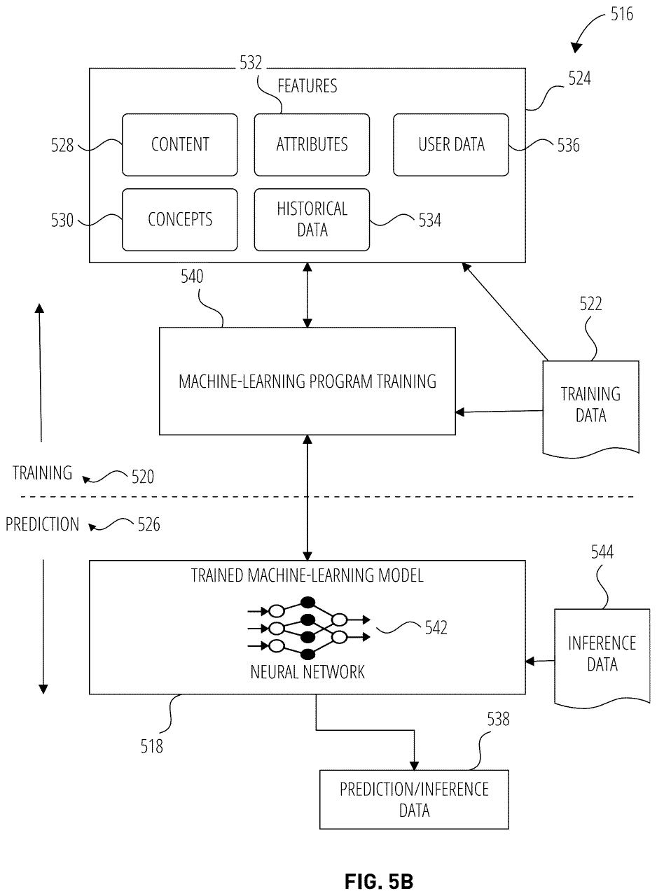

The feature extractor 430 uses a feature extraction model 409 to extract features of a hand 424 of the user 408 from the image data 422 captured by the one or more cameras 420. The feature extraction model 409 is trained to recognize features of the hand 424 as more fully described in reference to FIG. 5A and FIG. 5B. The feature extractor 430 generates an embedding 436 of the recognized features. The embedding 436 is used by the classifier 404 along with a classification model 440 to determine if the hand 424 of the user has previously been registered with the XR device 410 as more fully described in reference to FIG. 4B. If the hand 424 of the user 408 has been previously registered as confirmed by the classifier 404, the authentication pipeline 416 generates classification data 438 indicating that the user 408 is authorized to use one or more of the set of applications 444 and other features of the XR device 410. In some examples, the classification model 440 is partially trained to classify hands and then calibrated or re-trained in-situ using embeddings generated by the feature extractor 430 of the hand 424 of the user 408 during a registration phase or a calibration phase. For example, the XR device 410 uses a classification model 440 that undergoes a two-phase training process. The classification model 440 is first partially trained on a broader dataset to recognize general hand features, then specifically calibrated to an individual user during a registration or calibration phase. The feature extractor 430 generates embeddings of the hand 424 of the user 408, which are then used to fine-tune the classification model 440 for that specific user.

In some examples, the XR device 410 implements a personalized authentication system where the classification model 440 is initially trained using a large dataset of hand images to learn general vein pattern recognition capabilities. During user registration, the system captures multiple images of the user's hand 424 from different angles and in different lighting conditions. The feature extractor 430 processes these images to generate a set of user-specific embeddings that are used to calibrate the classification model 440 specifically for that user.

In additional examples, the XR device 410 employs an adaptive learning approach where the classification model 440 continues to refine its understanding of the user's hand characteristics over time. The XR device 410 stores multiple embeddings generated during different authentication sessions in the user specific parameters 450, allowing the classification model 440 to adapt to subtle changes in the user's hand appearance due to environmental factors or physiological changes. This in-situ retraining process maintains high authentication accuracy while operating entirely within the processing constraints of the XR device 410.

In some examples, a set of embeddings of the hand 424 of the user 408 used to re-train or calibrate the classifier 404 is stored in a datastore of user specific parameters 450 along with metadata of the user 408 and the registration process.

In some examples, a set of embeddings of the hand 424 of the user 408 used to re-train or calibrate the classifier 404 is deleted or destroyed along with all biometric data of the user collected during the recalibration process.

In some examples, the XR device 410 trains a set of classification models for a set of users, with each classification model assigned to a respective user. The multiple classification models are stored by the XR device 410 and associated with a user ID. This allows the XR device 410 to authenticate and accommodate multiple users. For example, the XR device 410 implements a multi-user authentication system by training a set of classification models, with each classification model specifically calibrated for a different user. The XR device 410 associates each classification model with a unique user ID in the datastore of user specific parameters 450, allowing the XR device 410 to maintain distinct authentication profiles for multiple users.

In some examples, the XR device 410 manages a database of classification models where each classification model is trained on the unique dorsal hand vein patterns of a specific registered user. During the authentication process, the feature extractor 430 generates an embedding 436 of the current user's hand, and the classifier 404 performs a sequential inference across the set of classification models using this embedding to identify which user, if any, is attempting to access the device. This approach enables the XR device 410 to support shared usage scenarios while maintaining individual user security and personalization.

In additional examples, the XR device 410 implements a multi-user management system that not only authenticates different users but also customizes the device experience based on the identified user. When a user is authenticated, the system loads user-specific settings, application preferences, and content access permissions associated with that user's ID. The classification models are continuously refined through ongoing use, with new hand images captured during successful authentication sessions used to update the corresponding user's model, improving recognition accuracy over time while maintaining the separation between different users' authentication data.

In some examples, an XR device performs the functions of the authentication pipeline 416, the user interface engine 406, and the optical engine 417 utilizing various APIs and system libraries.

FIG. 4B illustrates an example hand ID method 452 used by an XR device 410 to authorize a user 408 to use one or more functions or applications of the XR device 410 using images of a hand 424 of the user 408. Although the example hand ID method 452 depicts a particular sequence of operations, the sequence may be altered without departing from the scope of the present disclosure. For example, some of the operations depicted may be performed in parallel or in a different sequence that does not materially affect the function of the hand ID method 452. In other examples, different components of the XR device 410 that implement the hand ID method 452 may perform functions at substantially the same time or in a specific sequence.

In operation 454, the XR device 410 captures, using a set of cameras 420, image data 422 of the hand 424 of the user 408. The cameras 420 can include an array of optical sensors capable of capturing hand movements and gestures in real-time. In some examples, the cameras 420 comprise RGB cameras that capture images using light having a broad wavelength spectrum, such as natural light or artificial illumination provided by the XR device 410.

In some examples, the cameras 420 include infrared cameras that capture images using energy in the infrared radiation spectrum. The IR energy can be supplied by one or more IR emitters of the XR device 410. In some examples, the XR device 410 adjusts parameters of the image capturing process such as by adjusting an IR emitter intensity, an exposure time, a gain, an application of a gamma correction, and the like to optimize vein pattern visibility.

In some examples, the XR device 410 dynamically controls multiple imaging parameters to ensure optimal hand image capture across different environmental conditions. This includes automatically adjusting IR illumination levels based on ambient lighting, synchronizing multiple cameras to capture different angles simultaneously, and coordinating the timing between IR emitters and cameras to maximize vein pattern contrast. The system can also employ different IR wavelengths for varying depth penetration to enhance vein visibility.

In some examples, the XR device 410 provides feedback to the user 408 to guide hand positioning relative to a camera field of view. For example, the XR device 410 provides feedback through the XR user interface 418 to guide users in positioning their hands relative to the infrared camera 210 field of view. The system uses the optical engine 417 to generate visual guidance that helps users align their hands properly for authentication.

In some examples, the XR device 410 implements a user interface that provides real-time feedback about hand positioning. The system can display alignment guides through the optical engine 417 and provide visual indicators when the hand 424 moves in or out of the optimal capture zone of the set of cameras 420. In some examples, the alignment guides include audio cues to help guide the user. In additional examples, the alignment guides include haptic cues. The XR user interface controller 428 manages this feedback to ensure proper hand placement for reliable vein pattern capture.

In additional examples, the XR device 410 employs a guidance system that combines multiple feedback mechanisms. The system can display a 3D visualization showing the target hand position, provide progressive feedback as users move their hands closer to the optimal position, and indicate when environmental conditions like lighting might affect capture quality. The optical engine 417 can render these guidance elements while maintaining the user's view of their physical hand through the XR display.

In some examples, the XR device 410 provides guidance through the XR user interface 418 to direct users to form a fist with their hand and present the dorsal (back) side to the cameras 420. The system uses the optical engine 417 to display visual cues that help users properly position their hand in a fist pose that optimizes vein pattern capture. This fist pose helps make the vein patterns more prominent and consistent for imaging by creating tension in the skin and underlying tissues. The optical engine 417 provides real-time feedback to guide users in maintaining the proper fist position relative to the set of cameras 420.

In some examples, the XR device 410 can capture and process hand images in various poses and hand motion sequences, such as transitioning from a fist to stretched fingers and the like. By analyzing the specific way users transition between hand poses (e.g., from fist to stretched fingers), the XR device 410 can detect whether the authentication attempt is coming from a real user versus a static image or model of a hand, providing an additional layer of security.

In operation 456, the XR device 410 processes the image data 422 to enhance vein patterns in the hand 424 to generate enhanced vein pattern image data 466. For example, the authentication pipeline 416 uses an image processing component 464 to process the image data 422 using computer vision algorithms to generate enhanced vein pattern data.

In some examples, the feature extractor 430 applies computer vision techniques such as, but not limited to, CLAHE, a Frangi filter, and other enhancement methods to make the vein patterns more visible and distinct from surrounding tissue.

In some examples, the image processing component 464 uses a “vein X-Ray” algorithm that combines multiple computer vision techniques to process the images of the hand 424. The “vein X-Ray” process generates image data resembling an X-Ray image of the hand of the user using image data collected using light in the visible spectrum and/or infrared spectrum. As illustrated in FIG. 4C, this processing includes applying a set of one or more enhancing computer vision techniques to an original image 468 to generate an enhanced vein patterns image 470. The image processing component 464 applies additional enhancement methods to optimize the visibility of the vein patterns of the hand to generate an “X-Ray” vein image 472 that highlight the unique physiological features of the vascular structure of the hand 424.

In additional examples, the authentication pipeline 416 implements an image processing pipeline that dynamically adjusts enhancement parameters based on image quality and environmental conditions. The authentication pipeline 416 can modify contrast levels, apply different filtering techniques, and utilize multiple processing passes to generate optimal vein pattern visualization. In some examples, the feature extractor 430 is specifically designed to operate within the resource constraints of the XR device 410 while maintaining high-quality vein pattern enhancement.

In some examples, the XR device 410 adapts to the specific hardware configuration and operating conditions. The XR device 410 determines an optimal resolution for processing hand images based on multiple factors including the input resolution of the infrared camera, the distance between the hand and the camera, and other environmental variables. For example, a resolution of 128×128 pixels provides an effective balance between processing efficiency and authentication accuracy.

In some examples, the XR device 410 dynamically adjusts the processing resolution based on the specific characteristics of the captured images. While a particular resolution may work effectively with a particular IR camera configuration and typical hand-to-camera distances, the XR device 410 can adapt this parameter based on different hardware configurations or usage scenarios.

In additional examples, the XR device 410 implements a resolution management system that balances processing requirements with authentication accuracy. The XR device 410 can analyze the quality of captured images and adjust processing parameters accordingly, potentially using higher resolutions when additional detail is needed or lower resolutions to conserve processing resources. This adaptive approach ensures optimal performance across different XR device implementations with varying camera specifications and processing capabilities.

In operation 458, the XR device 410 generates a set of authentication features based on the enhanced vein patterns in the enhanced vein pattern image data 466. For example, the XR device 410 uses a feature extractor 430 to generate the set of authentication features from the enhanced vein pattern images. In some examples, the feature extractor 430 employs a feature extraction model 409 that has been pre-trained to recognize and extract distinctive characteristics from hand vein patterns as described in further detail in reference to FIG. 4A.

In some examples, feature extractor 430 detects hand features and/or feature points in the enhanced vein pattern image data 466 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST, Rotated BRIEF (ORB), KAZE, Frangi filters and the like as described more fully in reference to FIG. 4A.

In some examples, the feature extractor 430 creates a dimensional embedding representing the physiological characteristics of the hand 424. For example, the feature extractor 430 generates an embedding 436 of the set of authentication features that includes a multidimensional vector, providing a compact semantic representation of the unique vein patterns of the hand 424. This embedding allows for efficient on-device processing while maintaining the distinctive features needed for authentication. In some examples, the multidimensional vector is a 128 dimensional vector.

In some examples, the feature extractor 430 implements a feature extraction pipeline that combines multiple physiological characteristics in a multi-modal biometric analysis. The feature extractor 430 analyzes not only the enhanced vein patterns but also incorporates hand shape analysis, temporal data of hand movements, and finger proportion measurements. The feature extractor 430 generates the set of authentication features encoded in the embedding 436 that represent this combination of biometric markers, creating a robust multi-modal authentication signature while operating within the processing constraints of the XR device 410. For example, the feature extractor 430 analyzes the overall shape and structure of the hand 424 as part of generating the set of authentication features. The feature extractor 430 examines characteristics like hand proportions, finger lengths, and the spatial relationships between different parts of the hand to create distinctive biometric identifiers.

In some examples, generating authentication features includes analyzing temporal characteristics of hand movement. For example, the XR device 410 captures and analyzes temporal characteristics of hand movement as part of generating authentication features. The XR device 410 records the unique ways in which a user moves their hand during the authentication process, creating additional biometric identifiers beyond static vein patterns.

In some examples, the XR device 410 implements a multi-modal authentication approach that combines static vein pattern analysis with dynamic hand movement characteristics. The feature extractor 430 processes both the enhanced vein patterns and the temporal movement patterns of the hand 424, including speed, trajectory, and gesture sequences, to generate a more comprehensive set of authentication features. This approach enhances security by requiring both the correct physiological features and the correct movement patterns.

In additional examples, the XR device 410 employs a temporal analysis system that examines multiple movement characteristics. The system analyzes the specific way users present their hand to the camera, including rotation patterns, speed of movement, and characteristic tremors, micro-movements, vein pulsations caused by heartbeats that are unique to each individual. These temporal features are combined with the static biometric data to create a comprehensive authentication profile while maintaining efficient on-device processing.

For example, the XR device 410 implements a multi-modal authentication system that combines multiple biometric signals to enhance robustness across different environmental conditions. The XR device 410 uses a combination of dorsal vein patterns, hand shape analysis, and finger proportions to maintain authentication accuracy even when environmental factors affect individual biometric features.

In some examples, the XR device 410 dynamically adjusts its authentication strategy based on environmental conditions. When operating outdoors where lighting conditions may cause vein patterns to appear differently compared to indoor environments, the XR device 410 can place greater emphasis on other biometric signals such as hand shape and finger proportions. This adaptive approach ensures consistent authentication performance across varying usage scenarios.

In additional examples, the XR device 410 implements an environmental adaptation system that analyzes the quality of each biometric signal in real-time and adjusts their relative importance in the authentication decision. The authentication pipeline 416 can determine which biometric features provide the most reliable signals under the current environmental conditions and weight them accordingly in the classification process, maintaining robust authentication even in challenging outdoor environments.

In some examples, the feature extractor 430 implements a hand shape analysis system that examines multiple geometric and structural characteristics. The feature extractor 430 analyzes the ratios between different finger lengths, the relative positions of joints and knuckles, and the overall hand contour. These measurements are combined with the vein pattern data to create a comprehensive biometric profile while maintaining efficient on-device processing.

In operation 460, the XR device 410 generates a classification using the set of authentication features. For example, the XR device 410 uses a classifier 404 to generate a classification using the set of authentication features produced by the feature extractor 430. The classifier 404 uses a classification model 440 to determine if the hand 424 of the user has previously been registered with the XR device 410.

In some examples, the XR device 410 employs a lightweight classifier implemented directly on the device. The classifier 404 processes the multidimensional embedding vector generated by the feature extractor 430 to perform user authentication. This lightweight classification approach enables efficient on-device processing while maintaining high accuracy levels authentication. For example, the XR device 410 implements a lightweight classifier using a single-layer linear perceptron model to perform user authentication. The classifier 404 receives the embedding 436 as input features and processes them through weighted connections to generate a binary authentication decision. The classifier's architecture enables efficient on-device processing while maintaining high accuracy levels.

In some examples, the XR device 410 trains the classifier 404 during a registration phase using embeddings generated from multiple hand poses and angles. The system calibrates the classification model 440 weights using triplet loss to ensure embeddings from the same user's hand are classified similarly while embeddings from different users' hands are classified differently. The lightweight nature of the single-layer architecture allows the classifier to be retrained on-device as needed. In additional examples, the XR device 410 implements a classifier 404 that combines the single-layer perception model with additional processing stages. The classifier 404 first processes the embedding 436 through a set of weighted connections, then applies a step activation function to generate a binary output indicating whether the user is authenticated. The classification model 440 is specifically designed to operate within the processing constraints of the XR device.

In some examples, the XR device 410 implements an authentication pipeline 416 using a classification model 440 that is trained to position different vein images from different hands in a vector space in a way that maximizes the distance between them. The system employs a training methodology using triplet loss, which specifically optimizes the model to place embeddings from the same person's hand close together in the vector space while pushing embeddings from different people's hands far apart.

In some examples, the XR device 410 implements a feature extraction model 409 that is pre-trained using triplet loss to create a high-dimensional vector space where similar hands are clustered together and dissimilar hands are separated. A triplet loss algorithm determines if an image is close in a high dimensional space to another image. If the images are of the hands of different users, then the images will be far apart in the high dimensional space.”

In additional examples, the XR device 410 employs a training approach where the classification model 440 learns to distinguish between different users' hands by maximizing the vector distance between their respective vein patterns. The system creates a multidimensional embedding space where the distance between embeddings represents the similarity or dissimilarity between hand vein patterns. In some examples, the multidimensional space has 128 dimensions.

In some examples, the XR device 410 implements a classification pipeline that combines multiple authentication factors. The classifier 404 analyzes both the vein pattern embeddings and additional physiological features like hand shape, temporal hand motion, and finger proportions. The classification model 440 is partially trained to classify hands and then calibrated or re-trained in-situ using embeddings generated during a registration phase. The XR device 410 stores these registration embeddings along with user metadata in a datastore of user specific parameters 450.

In some examples, the authentication pipeline 416 performs a classification by comparing the set of authentication features to stored authentication data. For example, the authentication pipeline 416 uses the classifier 404 to compare the set of authentication features generated by the feature extractor 430 to stored authentication data. The classifier 404 processes the embedding 436 of the set of authentication features using the classification model 440 to determine if the hand 424 matches previously registered authentication data stored in the user specific parameters 450. In additional examples, the authentication pipeline 416 employs a comparison system that analyzes multiple biometric features. The classifier 404 compares both the vein pattern embeddings 436 and additional physiological characteristics like hand shape, temporal hand motions, and finger proportions against stored authentication data. The classification model 440 is calibrated during registration using embeddings generated from multiple hand poses and angles to create a robust authentication profile stored in the user specific parameters 450.

In operation 462, the XR device 410 controls access to the XR device 410 based on the classification. For example, the XR device 410 controls access to features and content based on the classification results generated by the classifier 404. The system uses the classification data 438 to determine whether to grant or deny access to specific applications 444 and other features of the XR device 410. For example, the XR device 410 can utilize the hand authentication system to associate corrected InterPupillary Distance (IPD) settings for users. The XR device 410 analyzes the biometric data captured during hand authentication to identify the specific user and automatically adjusts the IPD settings of the XR device to match that user's unique physiological requirements. This addresses a common challenge with XR devices, as each person has a distinct IPD that is necessary for proper alignment between virtual content and the real world.

In some examples, the XR device 410 implements a personalized device configuration system that uses the authentication results to automatically adjust multiple device parameters, including IPD. When the XR device 410 successfully authenticates a user through hand vein pattern recognition, it retrieves stored user-specific parameters that include the user's IPD measurements. The optical engine 417 then adjusts the display elements to match the user's IPD, ensuring optimal visual experience without requiring manual calibration.

In additional examples, the XR device 410 employs a calibration system that combines authentication with device personalization. The calibration system not only identifies the user through hand vein patterns but also maintains a profile of physical characteristics including IPD for each authenticated user. This integration of authentication and device configuration ensures that the XR experience is automatically optimized for each user's specific physiological characteristics, enhancing both comfort and the alignment between virtual and real-world elements.

In some examples, the XR device 410 implements granular access control based on the authentication results. The XR device 410 can selectively enable or disable specific content, applications, or device functions based on whether the user 408 is successfully authenticated. The classification data 438 is used by the XR device 410 to authorize the user 408 to use one or more of the set of applications 444 and other features.

In additional examples, the XR device 410 implements an access control system that manages multiple levels of device access. The XR device 410 can grant different levels of access privileges based on authentication confidence scores, restrict access to sensitive content or features until additional authentication factors are provided, and automatically revoke access when authentication can no longer be maintained. The access control decisions are made entirely on-device to maintain user privacy and security.

### Machine-Learning Pipeline

FIG. 5B is a flowchart depicting a machine-learning pipeline 516, according to some examples. The machine-learning pipeline 516 can be used to generate a trained machine-learning model 518 such as, but not limited to feature extraction model 409 of FIG. 4A and classification model 440 of FIG. 4A, and the like, to perform operations associated with authenticating a user by an XR device, such as XR device 410 of FIG. 4A.

Machine learning can involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that can be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting can be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

Generating a trained machine-learning model 518 can include multiple phases that form part of the machine-learning pipeline 516, including for example the following phases illustrated in FIG. 5A:
Data collection and preprocessing 502: This phase can include acquiring and cleaning data to ensure that it is suitable for use in the machine learning model. This phase can also include removing duplicates, handling missing values, and converting data into a suitable format.
Feature engineering 504: This phase can include selecting and transforming the training data 522 to create features that are useful for predicting the target variable. Feature engineering can include (1) receiving features 524 (e.g., as structured or labeled data in supervised learning) and/or (2) identifying features 524 (e.g., unstructured or unlabeled data for unsupervised learning) in training data 522.
Model selection and training 506: This phase can include selecting an appropriate machine learning algorithm and training it on the preprocessed data. This phase can further involve splitting the data into training and testing sets, using cross-validation to evaluate the model, and tuning hyperparameters to improve performance.
Model evaluation 508: This phase can include evaluating the performance of a trained model (e.g., the trained machine-learning model 518) on a separate testing dataset. This phase can help determine if the model is overfitting or underfitting and determine whether the model is suitable for deployment.
Prediction 510: This phase involves using a trained model (e.g., trained machine-learning model 518) to generate predictions on new, unseen data.
Validation, refinement or retraining 512: This phase can include updating a model based on feedback generated from the prediction phase, such as new data or user feedback.
Deployment 514: This phase can include integrating the trained model (e.g., the trained machine-learning model 518) into a more extensive system or application, such as a web service, mobile app, or IoT device. This phase can involve setting up APIs, building a user interface, and ensuring that the model is scalable and can handle large volumes of data.

FIG. 5B illustrates further details of two example phases, namely a training phase 520 (e.g., part of the model selection and trainings 506) and a prediction phase 526 (part of prediction 510). Prior to the training phase 520, feature engineering 504 is used to identify features 524. This can include identifying informative, discriminating, and independent features for effectively operating the trained machine-learning model 518 in pattern recognition, classification, and regression. In some examples, the training data 522 includes labeled data, known for pre-identified features 524 and one or more outcomes. Each of the features 524 can be a variable or attribute, such as an individual measurable property of a process, article, system, or phenomenon represented by a data set (e.g., the training data 522). Features 524 can also be of different types, such as numeric features, strings, and graphs, and can include one or more of content 528, concepts 530, attributes 532, historical data 534, and/or user data 536, merely for example.

In some examples, the training data 522 includes image data of the hands of a set of subjects captured using infrared and visible light cameras. During an image capturing session, the subjects are directed to hold each hand in a fist pose showing the dorsal side of a hand to a camera. In some examples, the images are captured using a camera that records images in the infrared light spectrum. In some examples, the images of the hands are captured using a camera that operates in the visible light spectrum. In some examples, the hands are illuminated using an IR emitter. In some examples, the hands are illuminated using a lamp emitting light in the visible spectrum.

In training phase 520, the machine-learning pipeline 516 uses the training data 522 to find correlations among the features 524 that affect a predicted outcome or prediction/inference data 538.

With the training data 522 and the identified features 524, the trained machine-learning model 518 is trained during the training phase 520 during machine-learning program training 540. The machine-learning program training 540 appraises values of the features 524 as they correlate to the training data 522. The result of the training is the trained machine-learning model 518 (e.g., a trained or learned model).

Further, the training phase 520 can involve machine learning, in which the training data 522 is structured (e.g., labeled during preprocessing operations). The trained machine-learning model 518 implements a neural network 542 capable of performing, for example, classification and clustering operations. In other examples, the training phase 520 can involve deep learning, in which the training data 522 is unstructured, and the trained machine-learning model 518 implements a deep neural network 542 that can perform both feature extraction and classification/clustering operations.

In some examples, a neural network 542 can be generated during the training phase 520, and implemented within the trained machine-learning model 518. The neural network 542 includes a hierarchical (e.g., layered) organization of neurons, with each layer consisting of multiple neurons or nodes. Neurons in the input layer receive the input data, while neurons in the output layer produce the final output of the network. Between the input and output layers, there can be one or more hidden layers, each consisting of multiple neurons.

Each neuron in the neural network 542 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks can use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 542 can also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 520, a validation phase can be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model can be tested on a new dataset. The testing dataset is used to evaluate the model's performance and ensure that the model has not overfitted the training data.

In prediction phase 526, the trained machine-learning model 518 uses the features 524 for analyzing inference data 544 to generate inferences, outcomes, or predictions, as examples of a prediction/inference data 538. For example, during prediction phase 526, the trained machine-learning model 518 generates an output. Inference data 544 is provided as an input to the trained machine-learning model 518, and the trained machine-learning model 518 generates the prediction/inference data 538 as output, responsive to receipt of the inference data 544.

In some examples, the trained machine-learning model 518 can be a generative AI model. Generative AI is a term that can refer to any type of artificial intelligence that can create new content from training data 522. For example, generative AI can produce text, images, video, audio, code, or synthetic data similar to the original data but not identical. In cases where the trained machine-learning model 518 is a generative AI, inference data 544 can include text, audio, image, video, numeric, or media content prompts and the output prediction/inference data 538 can include text, images, video, audio, code, or synthetic data.

Some of the techniques that can be used in generative AI are:
Convolutional Neural Networks (CNNs): CNNs can be used for image recognition and computer vision tasks. CNNs can, for example, be designed to extract features from images by using filters or kernels that scan the input image and highlight important patterns.
Recurrent Neural Networks (RNNs): RNNs can be used for processing sequential data, such as speech, text, and time series data, for example. RNNs employ feedback loops that allow them to capture temporal dependencies and remember past inputs.
Generative adversarial networks (GANs): GANs can include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs can encode input data into a latent space (e.g., a compressed representation) and then decode it back into output data. The latent space can be manipulated to generate new variations of the output data. VAEs can use self-attention mechanisms to process input data, allowing them to handle long text sequences and capture complex dependencies.
Transformer models: Transformer models can use attention mechanisms to learn the relationships between different parts of input data (such as words or pixels) and generate output data based on these relationships. Transformer models can handle sequential data, such as text or speech, as well as non-sequential data, such as images or code.

FIG. 6 is a block diagram 600 illustrating a software architecture 602, which can be installed on any one or more of the devices described herein. The software architecture 602 is supported by hardware such as a machine 604 that includes processors 606, memory 608, and I/O components 610. In this example, the software architecture 602 can be conceptualized as a stack of layers, where each layer provides a particular functionality. The software architecture 602 includes layers such as an operating system 612, libraries 614, frameworks 616, and applications 618. Operationally, the applications 618 invoke API calls 620 through the software stack and receive messages 622 in response to the API calls 620.

The operating system 612 manages hardware resources and provides common services. The operating system 612 includes, for example, a kernel 624, services 626, and drivers 628. The kernel 624 acts as an abstraction layer between the hardware and the other software layers. For example, the kernel 624 provides memory management, processor management (e.g., scheduling), component management, networking, and security settings, among other functionalities. The services 626 can provide other common services for the other software layers. The drivers 628 are responsible for controlling or interfacing with the underlying hardware. For instance, the drivers 628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 614 provide a common low-level infrastructure used by the applications 618. The libraries 614 can include system libraries 630 (e.g., C standard library) that provide functions such as memory allocation functions, string manipulation functions, mathematical functions, and the like. In addition, the libraries 614 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 614 can also include a wide variety of other libraries 634 to provide many other APIs to the applications 618.

The frameworks 616 provide a common high-level infrastructure that is used by the applications 618. For example, the frameworks 616 provide various graphical user interface (GUI) functions, high-level resource management, and high-level location services. The frameworks 616 can provide a broad spectrum of other APIs that can be used by the applications 618, some of which can be specific to a particular operating system or platform.

In an example, the applications 618 can include a home application 636, a contacts application 638, a browser application 640, a book reader application 642, a location application 644, a media application 646, a messaging application 648, a game application 650, and a broad assortment of other applications such as a third-party application 652. The applications 618 are programs that execute functions defined in the programs. Various programming languages can be employed to create one or more of the applications 618, structured in a variety of manners, such as object-oriented programming languages (e.g., Objective-C, Java, or C++) or procedural programming languages (e.g., C or assembly language). In a specific example, the third-party application 652 (e.g., an application developed using the ANDROID™ or IOS™ software development kit (SDK) by an entity other than the vendor of a platform) can be mobile software running on a mobile operating system such as IOS™, ANDROID™, WINDOWS® Phone, or another mobile operating system. In this example, the third-party application 652 can invoke the API calls 620 provided by the operating system 612 to facilitate functionalities described herein.

The applications 618 further include a compliance application 654. The compliance application 654 facilitates compliance by the XR device 410 with data privacy and other regulations, including for example the California Consumer Privacy Act (CCPA), General Data Protection Regulation (GDPR), and Digital Services Act (DSA). The compliance application 654 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance application 654 also incorporates opt-in/opt-out management and privacy controls across any digital interaction systems that the XR device 410 may be coupled to, empowering users to manage their data preferences. The compliance application 654 is designed to handle sensitive data by obtaining explicit consent, implementing strict access controls and in accordance with applicable laws.

Described implementations of the subject matter can include one or more features, alone or in combination as illustrated below by way of example.

Example 1 is a machine-implemented method comprising: capturing, using a set of cameras of an eXtended Reality (XR) device, images of a hand of a user; processing the images to generated enhanced vein patterns in the images of the hand; generating a set of authentication features based on the enhanced vein patterns; generating a classification using the set of authentication features; and controlling access to the XR device based on the classification.

In Example 2, the subject matter of Example 1 includes, wherein the set of cameras comprise infrared cameras.

In Example 3, the subject matter of any of Examples 1-2 includes, wherein processing the images comprises applying computer vision algorithms to generate vein pattern data.

In Example 4, the subject matter of any of Examples 1-3 includes, wherein generating the set of authentication features comprises creating a dimensional embedding representing physiological characteristics of the hand.

In Example 5, the subject matter of any of Examples 1-4 includes, wherein generating the classification comprises using a lightweight classifier implemented on the XR device.

In Example 6, the subject matter of any of Examples 1-5 includes, adjusting illumination parameters to optimize vein pattern capture by the set of cameras.

In Example 7, the subject matter of any of Examples 1-6 includes, wherein generating the set of authentication features comprises analyzing hand shape characteristics.

In Example 8, the subject matter of any of Examples 1-7 includes, wherein generating the set of authentication features comprises analyzing finger proportions.

In Example 9, the subject matter of any of Examples 1-8 includes, providing feedback to guide hand positioning relative to a camera field of view of the set of cameras.

In Example 10, the subject matter of any of Examples 1-9 includes, wherein generating the classification comprises comparing the set of authentication features to stored authentication data.

In Example 11, the subject matter of any of Examples 1-10 includes, wherein generating the set of authentication features comprises creating a vector representation of the enhanced vein patterns.

In Example 12, the subject matter of any of Examples 1-11 includes, capturing multiple images of the hand at different angles.

In Example 13, the subject matter of any of Examples 1-12 includes, wherein processing the images comprises applying contrast enhancement algorithms.

In Example 14, the subject matter of any of Examples 1-13 includes, wherein generating the classification comprises using a pre-trained feature extraction model.

In Example 15, the subject matter of any of Examples 1-14 includes, wherein controlling the access comprises granting or denying access to specific content on the XR device.

Example 16 is at least one machine-readable medium including instructions that, when executed by processing circuitry, cause the processing circuitry to perform operations to implement any of Examples 1-15.

Example 17 is an apparatus comprising means to implement any of Examples 1-15.

Example 18 is a system to implement any of Examples 1-15.

Example 19 is a method to implement any of Examples 1-15.

The various features, operations, or processes described herein can be used independently of one another, or can be combined in various ways. All possible combinations and sub-combinations are intended to fall within the scope of this disclosure. In addition, certain method or process blocks can be omitted in some implementations.

Although some examples, e.g., those depicted in the drawings, include a particular sequence of operations, the sequence can be altered without departing from the scope of the present disclosure. For example, some of the operations depicted can be performed in parallel or in a different sequence that does not materially affect the functions as described in the examples. In other examples, different components of an example device or system that implements an example method can perform functions at substantially the same time or in a specific sequence.

Changes and modifications can be made to the disclosed examples without departing from the scope of the present disclosure. These and other changes or modifications are intended to be included within the scope of the present disclosure, as expressed in the appended claims.

### Term Examples

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number can also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

“Carrier signal” can include, for example, any intangible medium that can store, encoding, or carrying instructions for execution by the machine and includes digital or analog communications signals or other intangible media to facilitate communication of such instructions. Instructions can be transmitted or received over a network using a transmission medium via a network interface device.

“Client device” can include, for example, any machine that interfaces to a network to obtain resources from one or more server systems or other client devices. A client device can be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user can use to access a network.

“Component” can include, for example, a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components. A “hardware component” is a tangible unit capable of performing certain operations and can be configured or arranged in a certain physical manner. In various examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein. A hardware component can also be implemented mechanically, electronically, or any suitable combination thereof. For example, a hardware component can include dedicated circuitry or logic that is permanently configured to perform certain operations. A hardware component can be a special-purpose processor, such as a field-programmable gate array (FPGA) or an application-specific integrated circuit (ASIC). A hardware component can also include programmable logic or circuitry that is temporarily configured by software to perform certain operations. For example, a hardware component can include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), can be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor can be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” can refer to a hardware component implemented using one or more processors. Similarly, the methods described herein can be at least partially processor-implemented, with a particular processor or processors being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some examples, the processors or processor-implemented components can be located in a single geographic location (e.g., within a home environment, an office environment, or a server farm). In other examples, the processors or processor-implemented components can be distributed across a number of geographic locations.

“Computer-readable medium” can include, for example, both machine-storage media and signal media. Thus, the terms include both storage devices/media and carrier waves/modulated data signals. The terms “machine-readable medium,” “computer-readable medium” and “device-readable medium” mean the same thing and can be used interchangeably in this disclosure.

“Machine-storage medium” can include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine-storage medium can also refer to cloud storage services, Network Attached Storage (NAS), Storage Area Networks (SAN), and object storage devices. The terms “machine-storage medium,” “device-storage medium,” “computer-storage medium” mean the same thing and can be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” can include, for example, one or more portions of a network that can be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network can include a wireless or cellular network, and the coupling can be a Code Division Multiple Access (CDMA) connection, a Global System for Mobile communications (GSM) connection, or other types of cellular or wireless coupling. In this example, the coupling can implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable medium” can include, for example, a tangible medium that is capable of storing, encoding, or carrying the instructions for execution by a machine.

“Processor” can include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” can include multi-core processors that can comprise two or more independent processors (sometimes referred to as “cores”) that can execute instructions contemporaneously. These cores can be homogeneous (e.g., all cores are identical, as in multicore CPUs) or heterogeneous (e.g., cores are not identical, as in many modern GPUs and some CPUs). In addition, the term “processor” can also encompass systems with a distributed architecture, where multiple processors are interconnected to perform tasks in a coordinated manner. This includes cluster computing, grid computing, and cloud computing infrastructures. Furthermore, the processor can be embedded in a device to control specific functions of that device, such as in an embedded system, or it can be part of a larger system, such as a server in a data center. The processor can also be virtualized in a software-defined infrastructure, where the processor's functions are emulated in software.

“Signal medium” can include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and can be used interchangeably in this disclosure.

“User device” can include, for example, a device accessed, controlled or owned by a user and with which the user interacts perform an action, engagement or interaction on the user device, including an interaction with other users or computer systems.

What is claimed is:

1. A machine-implemented method comprising:
capturing, using a set of cameras of an eXtended Reality (XR) device, images of a hand of a user;
processing the images to generate enhanced vein patterns in the images of the hand;
generating a set of authentication features based on the enhanced vein patterns;
generating a classification using the set of authentication features; and
controlling access to the XR device based on the classification.

2. The machine-implemented method of claim 1, wherein the set of cameras comprise infrared cameras.

3. The machine-implemented method of claim 1, wherein generating the set of authentication features comprises creating a dimensional embedding representing physiological characteristics of the hand.

4. The machine-implemented method of claim 1, wherein generating the classification comprises using a lightweight classifier implemented on the XR device.

5. The machine-implemented method of claim 1, further comprising adjusting illumination parameters to optimize vein pattern capture by the set of cameras.

6. The machine-implemented method of claim 1, wherein generating the set of authentication features comprises analyzing finger proportions.

7. The machine-implemented method of claim 1, wherein the XR device is a head-wearable apparatus.

8. A machine comprising:
at least one processor; and
at least one memory storing instructions that, when executed by the at least one processor, cause the machine to perform operations comprising:
capturing, using a set of cameras of an eXtended Reality (XR) device, images of a hand of a user;
processing the images to generate enhanced vein patterns in the images of the hand;
generating a set of authentication features based on the enhanced vein patterns;
generating a classification using the set of authentication features; and
controlling access to the XR device based on the classification.

9. The machine of claim 8, wherein the set of cameras comprise infrared cameras.

10. The machine of claim 8, wherein generating the set of authentication features comprises creating a dimensional embedding representing physiological characteristics of the hand.

11. The machine of claim 8, wherein generating the classification comprises using a lightweight classifier implemented on the XR device.

12. The machine of claim 8, wherein the operations further comprise adjusting illumination parameters to optimize vein pattern capture by the set of cameras.

13. The machine of claim 8, wherein generating the set of authentication features comprises analyzing finger proportions.

14. The machine of claim 8, wherein the XR device is a head-wearable apparatus.

15. A machine-storage medium, the machine-storage medium including instructions that, when executed by a machine, cause the machine to perform operations comprising:
capturing, using a set of cameras of an eXtended Reality (XR) device, images of a hand of a user;
processing the images to generate enhanced vein patterns in the images of the hand;
generating a set of authentication features based on the enhanced vein patterns;
generating a classification using the set of authentication features; and
controlling access to the XR device based on the classification.

16. The machine-storage medium of claim 15, wherein the set of cameras comprise infrared cameras.

17. The machine-storage medium of claim 15, wherein generating the set of authentication features comprises creating a dimensional embedding representing physiological characteristics of the hand.

18. The machine-storage medium of claim 15, wherein generating the classification comprises using a lightweight classifier implemented on the XR device.

19. The machine-storage medium of claim 15, wherein the operations further comprise adjusting illumination parameters to optimize vein pattern capture by the set of cameras.

20. The machine-storage medium of claim 15, wherein the XR device is a head-wearable apparatus.
